(19) United States
(12) Patent Application Publication
(10) Pub. No.: US 2005/0111233 A1
(43) Pub. Date: May 26, 2005

(54) Tunable compact forensic light source

(76) Inventors: Nicolas Vezard, Metuchen, NJ (US); Gregoire Verrier, Iselin, NJ (US); Chien Bui, Litica, NY (US); Mike Carrabba, South Plainfieco, NJ (US); Xiaomei Tong, Edison, NJ (US)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/723,458

(22) Filed: Nov. 26, 2003

(51) Int. Cl. G02B 7/02; F21V 7/04; G05D 25/00

(52) U.S. Cl. 362/552

(57) ABSTRACT

A forensic light source which comprises a flexible liquid light guide receiving light from a light source and transmitting it to a selected interference filter which tilts with respect to the light source is disclosed. The filter is mounted for rotation with respect to the output of the light guide. The light exiting the filter is passed through a mixing member made of a randomized fiber optic bundle, that is positioned to receive the output of the filter. The mixing member defines multiple paths for light between the input face and the output face which are configured to disperse light from one mixing member input face region to a plurality of mixing member output face regions.

### TECHNICAL FIELD

The invention relates to a compact, optionally self-powered, forensic light source with structure for conveniently tilting and rotating a filter wheel holding a plurality of filters to fine tune output wavelength and mix output wavelengths, thus eliminating any spatial dispersion in the output.

### STATEMENT REGARDING FEDERALLY SPONSORED RESEARCH OR DEVELOPMENT

Not Applicable.

### BACKGROUND OF THE INVENTION

Light sources which output light for a variety of analytic purposes are in wide use today. Such uses primarily involve forensic analysis, although such light sources are of value in a range of other applications. These devices may output white light, colored light or have the ability to output illumination of, to varying degrees, a selectable wavelength.

Special tools are frequently used by law enforcement personnel when evaluating a crime scene to collect forensic evidence that may be hard to see or invisible to the human eye. Examples of such evidence include bodily fluids, fingerprints on porous and non-porous surfaces, forged documents, explosive residue, and trace evidence e.g., hair, fibers, etc.

One commonly used tool is a forensic light source that utilizes fluorescent light to detect and record forensic evidence. Subjects illuminated by a forensic light source may be viewed through light filtering goggles, and the output of the source may be filtered to achieve a range of diverse functionalities and corresponding capabilities, with and without the use of chemical developers, powders and dyes.

At the present time, a wide variety of forensic light sources are employed by law enforcement and other personnel. In one class of devices, a portable light source unit which, for example, may be handheld or supported on a shoulder strap, is adapted to accept an elongated flexible light pipe, which may comprise a liquid light guide, a fiber-optic bundle, or other similar device.

Recent advances in DNA testing have rendered the gathering of forensic materials of increasing importance. However, even before the advent of DNA testing, the detection of forensic materials such as blood, perspiration, bone, skin, and the like has always been of importance to criminal investigation. For example, bone fragments that can be matched to a body may show that the individual who had suffered the crime may have been at a particular location. Fingerprints may identify individuals because of their unique characteristic. Loose hairs on a victim's clothes could identify a possible assailant.

As important as forensic evidence was in the past, it was only one of numerous circumstantial and objective sources of evidence which are weighed by juries and judges in their search for the truth and implementation of criminal justice objectives aimed at punishing and/or preventing criminal activities.

With the advent of DNA testing, forensic material can yield information which may be interpreted with particular reliability to help in a determination respecting certain types of criminal activity and even more reliable and determinative evidence with respect to other types of criminal activity.

Accordingly, the detection of forensic materials at a crime scene is of the utmost importance, given the need to make an almost positive connection between a genuinely guilty criminal and a crime scene, and to exonerate innocent people.

One of the primary tools in detecting forensic materials is the use of light having particular wavelength characteristics. More particularly, various types of forensic light sources include means to direct light onto various parts of a crime scene.

As noted above, the ability to produce light of different wavelengths is important in a wide variety of applications. Accordingly, wheels containing a plurality of filters having various wavelength bandpass characteristics may be employed. Such wheels are rotated to various angular positions, resulting in the interposition of a selected filter with a selected wavelength bandpass characteristic in front of the light source to filter the light source and produce output light of a desired wavelength. In some devices, these filter wheels are included in a portable light source unit. In other units, a filter wheel is positioned proximate to the output of the fiber-optic bundle.

One typical device, for example, comprises a light source and a six foot long fiber optic snake-like member which directs light from the light source to a point at which the end of the fiber optic member is pointed. A wheel containing a number of filters is mounted at the end of the fiber optic light pipe. In order to select various wavelengths, the wheel is rotated thus interposing different filters in front of the output of the light pipe. The result is that the filters filter the light as it comes out of the light pipe and allow only the light of a particular wavelength to fall on an object or area to be illuminated.

Devices in which the filter wheel is positioned proximate to the output of the fiber-optic bundle offer the convenience of quick adjustment of the wavelength of output light by the same hand that is holding the end of the fiber-optic bundle and aiming the output light at the subject to be illuminated.

Interference filters are of particular value in forensic light sources. In addition to their efficiency, such filters, mounted on wheels enclosed in a light source housing that couples light to a fiber optic bundle, offer the possibility of producing, not just a single wavelength, but a range of wavelengths. This is achieved by tilting the filter. In accordance with Bragg's law, the wavelength that is output by such a filter is a function of the distance between reflecting planes in the filter. Accordingly, a method for obtaining a range of different wavelengths from a single filter is to tilt the filter wheel. Tilting the filter wheel causes it to pass progressively longer wavelengths, and thus allows users to fine tune the wavelength of output light.

Generally, prior art forensic light sources comprise small self-contained units which directly output filtered or unfiltered light, that is, usually, colored or white light, respectively. Larger, somewhat more difficult to use units, also use mechanisms for tilting the filter, and further utilize a snake-like fiber-optic bundle or similar member to direct light in a particular direction. Such devices are somewhat difficult to use, as one hand must be used to hold the unit, while the other hand must be used to aim the light.

### SUMMARY OF THE INVENTION

In devices in which the tunable light source is embodied by a filter wheel located within the portable light source unit, the length and characteristics of the light pipe, such as a liquid light guide, results in mixing the wavelengths, thus eliminating any spatial dispersion.

However, if one wishes, instead, to place the filtering mechanism, whether it be on a wheel of filters or whether the filtering mechanism be a single filter, at the output of the liquid light guide, tilting of the filter we cause a non uniform wavelength variation in output light which is a function of the part of the filter through which the light has passed. This cannot be tolerated in many applications. Accordingly, if one is using such a light to inspect an area for evidence, or the like, the picture which is presented, whether it be to the human eye directly, or to a camera of any sort, will exhibit a variation and uniformity which may obscure important features. This may be of particular importance in the case of image resolution using artificial intelligence systems, human inspection, analysis of pictures taken with the forensic light source, and so forth.

In accordance with the present invention, objectives of compactness, continuously variable wavelength adjustment and single-handed operation are achieved in the context of a system which comprises a light source contained within a housing. Light is focused by the optics and passed through a filter positioned on the housing of the forensic light source at the output of the forensic light source. In accordance with a preferred embodiment, the hand of the user that is holding the unit may be used to rotate a wheel holding one or more filter wheels to select a desired filtering characteristic or no filtering. Grasping is done with the four fingers of the hand, with the thumb being used to rotate the filter wheels.

The housing includes a handle attached to the housing which allows the housing to be grasped by a user. Light is output from the housing through a filter wheel mounted on the housing. A plurality of filters, for example six filters may be mounted in the filter wheel. Alternatively, five filters may be mounted within the filter wheel, and the sixth position left open to output unfiltered white light.

The filter wheel is positioned to allow for filter selection using the thumb of the hand which is grasping the handle of the housing, while the other four fingers engage the handle to hold the housing in position. The same is achieved by having the filter wheels mounted in front of the output of the light source within the housing which is grasped by the hand.

In connection with this, it is noted that if one simply provides for filter tilting in forensic light sources where the filter is positioned at the output of the unit, the difference in path length between the unfiltered output of the light guide and the filter causes a corresponding wavelength variation across the beam output from the filter. This difference is a result of the different path length through the filter between the unfiltered light output of the light guide and the various parts of the filter. More particularly, in the case where the path length is relatively large, the filter tends to pass light of relatively longer wavelength. The particular wavelength selected is a function of Bragg's law.

As a consequence of these variations in the output wavelength, light exiting a filter in a system where the filter wheel is carried inside the housing of the light source suffers from the condition of producing various wavelengths at the filter output which vary from the primary wavelength of the filter through a range of longer wavelengths, which range of length is greater for increasingly greater angles of filter tilt. This range of longer wavelengths does not present a problem in fiber optic light guide bundle systems, because, as long as the light guide is of a typical length, it has the characteristic of mixing these wavelengths together, because of the various path lengths which are associated with the different rays of light passing through the light guide, the result is to mix them substantially uniformly with a distribution across the diameter of the light guide output face. The result is a substantially uniform illumination with substantially the same wavelength content across the output face of the forensic light source.

However, if one wishes, instead, to directly use the output of the filtering mechanism, whether it be on a wheel of filters or whether the filtering mechanism be a single filter, wavelength variation in output light which passes through various parts of the filter will be visible. Accordingly, if one is using such a light to inspect an area for evidence, or the like, the picture which is presented, whether it be to the human eye directly, or to a camera of any sort, will exhibit a variation and non-uniformity which may obscure important features. This would be expected to be of particular importance in the case of image resolution using artificial intelligence systems, human inspections, demographic analysis of pictures taken with the forensic light source, and so forth.

In accordance with the invention, this problem is solved through the provision of a forensic light source comprising a source of light, and a flexible light guide for receiving light from the source. The output of the light guide is passed through a filter on a filter wheel mounted for rotation and tilting with respect to the output of the light guide. Light exiting the filter is passed through a mixing member. The output of the mixing member may then be used as the output of the system for forensic lighting purposes. In accordance with the preferred embodiment of the invention, the mixing member may be a relatively short rod of transparent material, made, for example, of quartz, or other material if ultraviolet light output is not needed.

Alternatively, the mixer may be made of randomized fiber-optics. However, a liquid light guide is preferred because randomized fiber-optics tend to show multiple small spots in the focused output beam.

Still yet another approach is the use of an integrating sphere which performs the function of integrating or mixing the light output. The sphere is coated on the inside with a strongly reflecting material, and features an entrance port and exit port. After high numbers of reflection, the rays exit and have lost any spatial non uniformity information. However, the use of such integrating sphere systems suffer from the disability of relatively greater reductions in the amplitude of light output by the system, and a space requirement concern not well adapted for hand-held use.

Similarly, an optical system may be designed for integrating the filter output, but ray tracing would seem to have relatively large losses in such a system, because ray tracing would seem to imply not collecting all the light exiting the system. This would have the additional disadvantage of causing losses so great that the handle would be warmed to the point of even causing burns.

Still yet another alternative embodiment of the present invention contemplates the manufacture of special liquid light guides that feature an F number which is compatible with 1 inch diameter filters, as this is the size of filters which are currently in use in forensic systems around the world. Such a liquid light guide allows the use of lenses between the light guide and the tiltable filters. This limits the spatial dispersion in the system, and such a solution would increase the cost of the system, as such light guides would have to be produced especially for such a system. Accordingly, such light guides would involve customizations for forensic allocations and accordingly low production volumes from the current light guide standard of numerical average or 0.588 corresponding to a half convergence angle of 36 degrees.

Similarly, an optical system may be designed for integrating the filter output, but ray tracing would seem to predict relatively large losses in such a system, because ray tracing would seem to imply not collecting the entire light exiting the liquid light guide. This would have the additional disadvantage of causing losses so great that the handle would be warmed to the point of even causing burns.

Still yet another alternative embodiment of the present invention contemplates the manufacture of special liquid light guides that feature an F number which is compatible with one inch diameter filters, as this is the size of filters which are currently in use in forensic systems around the world. Such a liquid light guide allows the use of lenses between the light guide and the tiltable filters that limit spatial dispersion in the system, although such a solution increases the cost of the system, as such light guides have to be produced especially for such as system. Accordingly, such light guides involve customizations for forensic allocations and accordingly low production volumes from the current light guide standard of numerical average of 0.588 corresponding to a half convergence angle of 36 degrees.

In accordance with the preferred embodiment of the invention, a mixing rod having a 12 mm diameter and a length between 60 and 80 millimeters is used in connection with a high collection input lens (for example F/1) and an outlet lens, with a 90 mm focal light.

A quartz rod may be obtained from Technical Glass Products of 881 Callendar Blvd.,Painesville Twp., Ohio 44077. The rod is polished very finely on the ends and the cylindrical sidewall in order to avoid light leaks. The rod is held in a metal tube with just two areas of contact that its ends where it is supported by narrow lips to minimize the light losses, and where epoxy for index of refraction matching is used to further eliminate light losses.

This rod may be made of BK7, quartz or similar material, or in the case where ultraviolet light is not required it may be made of glass. This rod is finely polished on both ends and on its cylindrical sidewall. General Electric epoxy is used to cement the system together, as the index of refraction of the cement must be carefully matched to avoid local losses. Generally the use of General Electric epoxy in optical systems for the purpose of index of refraction matching is well-known in the art.

### BRIEF DESCRIPTION OF THE DRAWINGS

The present invention may be understood from the following drawings, which illustrate only several embodiments of the invention, and in which:

FIG. 1 is a diagrammatic view of a forensic light source according to the present invention illustrating the output of the light guide being passed through a filter mounted for rotation, then through a mixing member with the output to be used as a forensic output light;

FIG. 2 illustrates an alternative mixing member comprising a plurality of transparent integrating spheres contained within a cylindrical member;

FIG. 3 illustrates a randomizing fiber optic member;

FIG. 4 illustrates an alternative housing configuration for the inventive forensic light source;

FIG. 5 illustrates yet another alternative housing configuration;

FIG. 6 is a diagrammatic detailed illustration showing how movement of a disk-like support member results in the rotation of the fiber optic member for the purpose of wavelength shifting;

FIG. 7 is a diagrammatic illustration showing illustrative optics at the input and output of the mixing member;

FIG. 8 illustrates an embodiment of the invention with two filters on rotation mechanisms allowing them to be rotated equal amounts in opposite angular directions simultaneously;

FIG. 9 is a diagrammatic view in cross-section of another example of a forensic light source constructed according to the present invention;

FIG. 10 is a cross-sectional view along lines 10-10 of FIG. 9;

FIG. 11 is a cross-sectional view along lines 11-11 of FIG. 10;

FIG. 12 is a bottom plan view along lines 12-12 of FIG. 9;

FIG. 13 is a perspective view of the embodiment of FIG. 9;

FIG. 14 is a view similar to that of FIG. 13 illustrating an elongated light directing member;

FIG. 15 is a diagrammatic view of a forensic light source similar to that of the FIG. 9 embodiment, showing an alternative rotating mechanism;

FIG. 16 is a view along lines 16-16 of FIG. 15 illustrating only the filter support rotation mechanism;

FIG. 17 is a view along lines 17-17 of FIG. 15 illustrating only the filter support rotation mechanism;

FIG. 18 is a diagrammatic illustration of a forensic light source according to the present invention having a pair of independently adjustable filters;

FIG. 19 illustrates wavelength shifting of the mounting structure of the light source of FIG. 18;

FIG. 20 illustrates a rectangular randomizing optical member;

FIG. 21 illustrates yet another randomizing optical member;

FIG. 22 illustrates another forensic source member with an alternative filter tilting mechanism;

FIG. 23 illustrates the source of FIG. 22 coupled to a power supply and light source unit;

FIG. 24 illustrates mechanical details of the tilting arrangement of the source of FIG. 23;

FIG. 25 illustrates the details of structure of a heat sink useful in the embodiment of FIG. 24; and

FIG. 26 illustrates the heat sink of FIG. 25 viewed along the lines 26-26 of FIG. 25.

### DETAILED DESCRIPTION OF THE PREFERRED EMBODIMENT

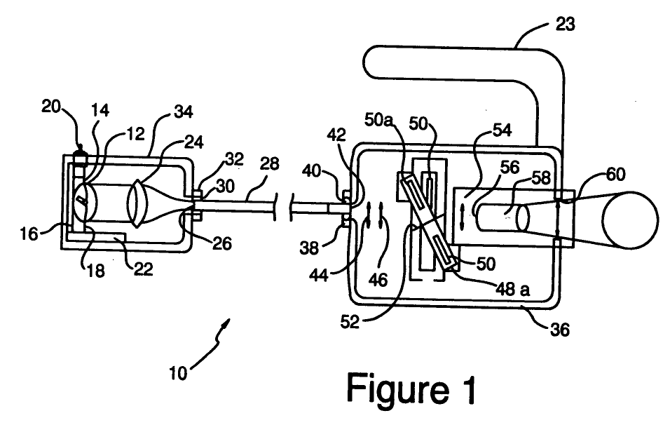

Referring to FIG. 1, a forensic light source 10 constructed in accordance with the preferred embodiment is illustrated. Light source 10 comprises a lamp 12 for producing light, such as white light. Lamp 12 may be one of the many alternatives employed in the art, such as a xenon lamp. Lamp 12 is coupled by a plurality of wires 14, 16, 18, and a switch 20, to a battery 22, which may be of any desired type, such as lithium ion.

A handle 23 allows the device to be conveniently held and aimed during use.

The output of lamp 12 is sent to a lens 24, which focuses it onto the input face 26 of a liquid light guide 28. Liquid light guide 28 is configured with a mounting 30 which couples to a mating mounting 32 on housing 34. Mountings 30 and 32 are positioned at a first end of the light guide 28. Mountings 30 and 32 may provide for any desired mounting type, such as a screw mounting, a bayonet mounting, or other mounting structure. In a similar fashion, handheld housing 36 is provided with a mounting 38 which mates with a mounting 40 on the other end of light guide 28.

Light exiting the face 42 of liquid light guide 28 passes through a pair of 18.5 mm focal length lenses 44 and 46. Light is next passed to a wheel 48 having a plurality of filters 50 mounted for rotation about an axle 52. Lenses 44 and 46 and output face 42 are positioned in alignment with each other and are further positioned to output substantially all of the light exiting face 42 through one of the filters 50, depending upon which filter 50 is rotated into the output position.

The output of the selected filter 50, is, in turn, coupled to a lens 54, which is positioned to receive substantially all of the light output by the selected filter 50. This light is then coupled into the input face 56 of mixing rod 58, which may be made of quartz, for example, and has a diameter of ten centimeters and a length of between 16 and 80 cm, although the diameter and length may be varied as a function of the optical system and the desired degree of mixing. It is also noted that a relatively long mixing optic 58 can be tolerated in the system. Longer optics may be employed for better mixing. The output of mixing optic 58 is, in turn, coupled to an output lens 60 which has a focal length of, for example, 90 mm. Output lens 60 may be a 90 mm lens of the type typically used in a 35 mm camera, and then used to focus the beam at various working distances ranging from, for example, 2 cm to 5 m. Moreover, by adjustment of lens 60, the size of the beam presented by the system over the area to be inspected for forensic evidence may be varied, as desired. As will be understood from the within description, light focused into a relatively small area will be relatively intense, while light focused into a wider area will exhibit less intense illumination.

As will be understood with reference to FIG. 1, filters 50 may be slanted as shown that reference numeral 50a in response to tilting of wheel 48 to the position indicated by reference numeral 48a.

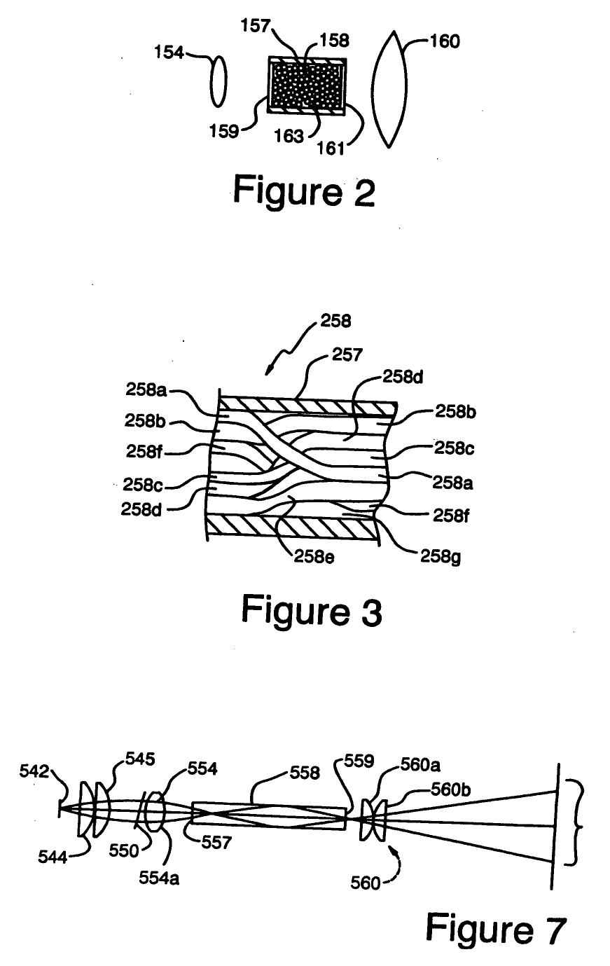

In accordance with the present invention, it is contemplated that alternative optical elements may be used to perform the mixing function performed by mixing rod 58 in the embodiment of FIG. 1. For example, as illustrated in FIG. 2, mixing rod 58 may be replaced by a plurality of integrating transparent spheres 158. Integrating spheres 158 are contained within a cylindrical member 157 including transparent end closures 159 and 161. In accordance with preferred embodiment the efficiency of the device is improved through the use of a reflective coating 163, inside of cylindrical member 157.

In a manner similar to the functioning of collection and focusing lenses 54 and 60 in the FIG. 1 embodiment, collection lens 154 focuses light onto transparent input face 159. Similarly, light output from transparent integrating spheres 158 is focused by lens 160.

Still yet another possibility is achieved through the use of a randomizing fiber-optic member as illustrated in FIG. 3. In this embodiment, mixing of wavelengths is achieved by a randomizing fiber-optic member 58 comprising a plurality of fiber optic elements 258a-g contained within a cylindrical member 257. In this embodiment, the input faces of fiber optic elements 258a-g bear a substantially random spatial relationship to the output faces of fiber-optic elements 258a-g, thus effectively mixing the output.

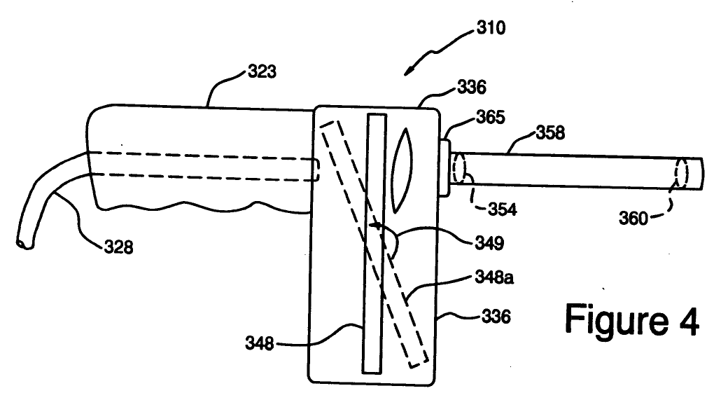

Referring to FIG. 4, an embodiment of the invention showing an alternative housing configuration is illustrated. In this embodiment, forensic light source 310 comprises a handle 323 which contains fiber-optic member 328. A housing 336 contains filter 348, which is mounted for rotation in the direction indicated by arrow 349 to the position indicated at 348a. A transparent rectangular mixing assembly 358 may be secured on mounting 365. In accordance with the invention, mixing assembly 358 includes both a collection lens 354 and a focusing lens 360.

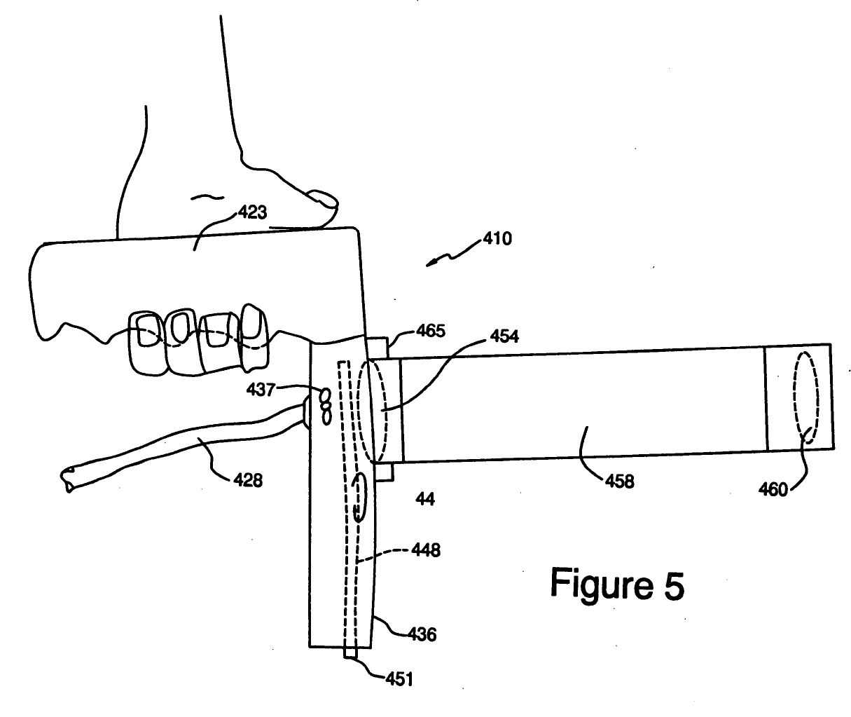

Still yet another housing configuration is illustrated in FIG. 5. As illustrated in FIG. 5, forensic light source 410 comprises a handle 423 which is positioned above fiber-optic member 428. A housing 436 contains filter wheel 448, which is mounted for rotation in the direction indicated by arrow 449, and which may be rotated by engagement of the finger of the user with the periphery 451 of the wheel. An optionally removable (for example by bayonet or screw mount) transparent rectangular mixing assembly 458 may be secured on a mounting 465. In accordance with the invention, mixing assembly 458 includes both a collection lens 454 and a focusing lens 460.

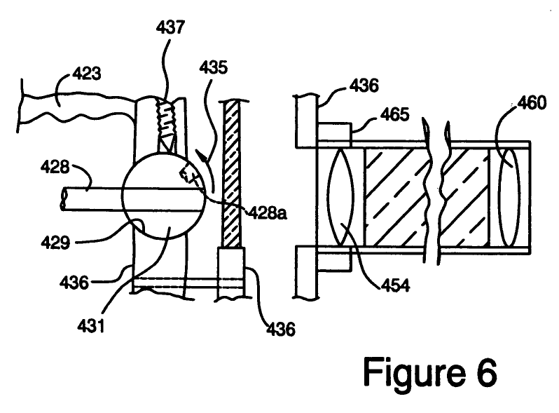

As may be seen from the detail of FIG. 6, fiber-optic member 428 is mounted in a cylindrical seat 429 in housing 436. Seat 429 mates with circular disk-like support member 431. Disk-like support member 431 is slidably mounted in seat 429 and thus allows the end 433 of fiber-optic member 428 to be rotated as indicated by arrow 435. Movement of disk-like support member 431 results, for example, in placing the fiber-optic member in the position indicated at 428a in FIG. 6. The angular orientation of the fiber optic member may be maintained in any desired position through the use of a wing bolt 437 which is tightened against disk 431.

An optical arrangement suitable for use in the embodiment of FIG. 4 is illustrated in FIG. 7. In this embodiment, a relatively uniform color effect is achieved through the use of a quartz rod 558. Input lens 44 is made of quartz. Lens 544 is coupled to the output face 542 of the fiber-optic light guide. Lens 544 is also made of quartz. Light from lens 544 is further focused by lens 545, passed through filter 550, which is mounted for rotation, and then focused further by lens 554. Lens 554 is also made of quartz. Mixing rod 558 has a length of 70 mm and a round cross-section with a diameter of 10 mm. Mixing rod 558 is separated by 13 mm from the output face 554a of lens 554.

Light from the output face 542 of the fiber-optic light guide is first caused to fall upon lens 544 and then passed on through lens 545 after which it is filtered by filter 550. The filtered light is then passed through lens 554 through the light mixing guide 558 to result in the creation of an output spot 559 on a workpiece. As noted above, an output focusing length is not absolutely required, although use of one will result in control of the size of the area of illumination 559 at various distances from the system.

The configuration illustrated in FIG. 7 may be used in conjunction with a square rod having a 10 mm by 10 mm cross-section and length of 50 mm if an output lens 560 is used. Lens 560, illustrated in dashed lines, comprises a first plano convex lens 560a and a second lens, lens 560b.

In the embodiment of FIG. 7, all of the optical elements may be made of quartz. Filter 550 may be positioned at any distance from lens 545 which is between lens 545 and lens 554. After the output light has been mixed and exits face 559 of mixing rod 558, a wide variety of focusing lens as may be used with configurations well-known to those of skill in the art, depending upon the width of the beam of light desired at a particular distance.

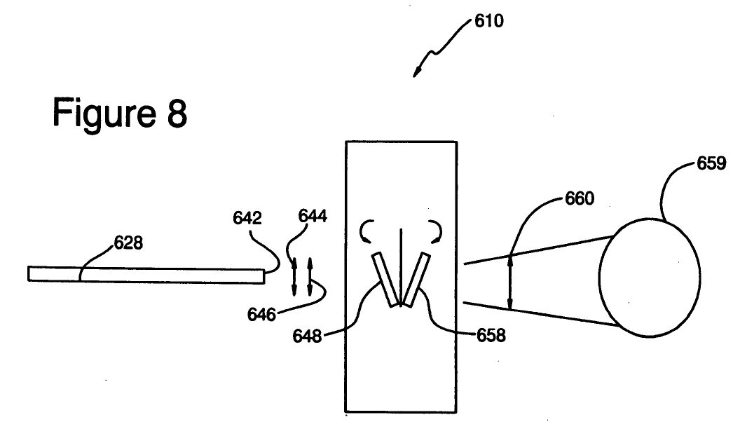

Still yet another mechanism for achieving color uniformity in the bandpass shifted output of a forensic light source 610 is illustrated in FIG. 8. In a manner similar to that of the FIG. 1 embodiment, a liquid light guide 628 with an output face 642 outputs light to a pair of lenses 644 and 646 which focus light through a wavelength shifting filter 648. Color equalization is provided by a second filter 658 whose output is focused by an output lens 660 to form an output spot of light 659. It is contemplated that output spot of light 659 may also be formed as a square, rectangular or other shape.

In accordance with the embodiment illustrated in FIG. 8, filters 648 and 658 are mounted on rotation mechanisms which cause them to be rotated equal amounts in opposite angular directions simultaneously. Thus, for example, filters 648 and 658 may be oriented parallel to each other. Alternatively, they may be oriented in opposite directions with equal angular deviations from the parallel, as illustrated in FIG. 8. In addition, it is contemplated in accordance with the invention that filters 648 and 658 are each only one of a plurality of filters, having different wavelength bandpass characteristics, and which are mounted on respective wheels which may be rotated to select the desired filter.

As it may be understood with reference to FIG. 8, rotation of filter 648, in addition to causing a first-order wavelength shift of a given value in the output of filter 648, will also cause a second-order wavelength variation characteristic across the output of filter 648. Because filter 658 is rotated by the same magnitude of angle as the angle at which filter 648 is displaced angularly, it will also have a first-order wavelength shift of the same given value. However, because the sign of the angle is opposite, the second-order wavelength variation characteristic across the face of filter 658 is the opposite of the second-order wavelength variation characteristic across the output of filter 648, the spatial dispersions of filter 648 and 658 combine to cancel each other.

In the case of all embodiments of the invention, it is necessary for the wheel to be mounted for tilting and rotation simultaneously. The same may be most advantageously achieved in accordance with the present invention by the mechanism illustrated in FIG. 9.

Referring to FIG. 9, an alternative inventive forensic light source 710 is illustrated. Forensic light source 710 includes a housing 712 which may be grasped by the user using a handle 714. More particularly, as illustrated in FIG. 9, the user uses the unit by grasping handle 714 with his hand 716. The unit 710 is controlled by a bandpass filter wavelength selector dial 718, which takes the form of the rim of a wheel carrying a plurality of filters as will be described in detail below. The user positions his hand 716 in such a manner that thumb 722 of hand 716 may be placed over dial 718 and the thumb may be selectively used to rotate dial 718 to a desired position.

Handle 714 on housing 712 includes an on/off switch 724. Switch 724 is used to turn a light source, such as lamp 726, on and off. Lamp 726, which may be mounted in housing 712 on shock absorbing supports, may be any of numerous lamps employed in such instruments, such as for example, a xenon lamp or other suitable source. Suitability for employment in forensic light source 710 is determined by the spectral emission of the lamp. In particular, lamps having sufficiently high light output within the desired output range of the instrument are suitable. The exact nature of the xenon lamp or any other suitable lamp is not a feature of this invention.

The system also includes a fan 728, which may be powered by being connected electrically in parallel with lamp 726, whereby actuation of switch 724 results in turning both lamp 726 on and turning fan 728 on, thus providing for the cooling of the unit during use. Fan 728 is mounted adjacent to a port 730 for the input and circulation of air. Port 730 is located on the rear of the unit as illustrated in FIG. 9. Port 730 may be a simple circular hole or a plurality of holes and may be covered by a screen (and optionally an air filter) made of wire to prevent the introduction of foreign objects. Because it is desired that there be a flow of air through the instrument, a set of vents 734 are provided near the opposite end of housing 712.

In connection with venting it is noted that switch 724 may be made to individually control fan 728 and light source 726. More particularly, if desired, it is also possible for switch 724 to be a three way switch in which the first position has both the fan and the light source off, in a second position sends power only to fan 728 and in a third position sends power to fan 728 and light source 726. This allows the light source to be turned off while still continuing cooling, thus preserving the life of the unit.

As illustrated in FIG. 9, the optical system in forensic light source 710 further comprises a reflector 736 positioned to couple light output from lamp 726 to focusing optics 738. Focusing optics 738 may comprise a plurality of focusing members, such as refractive members 739 and 741 which function to concentrate light directly received from lamp 726 and indirectly received from lamp 276 by reflector 736 to the output of the system.

A filter wheel 740 is positioned within housing 712. Referring to FIG. 10 taken in conjunction with FIG. 9, it is seen that filter wheel 740 has a mounting hole 744 which supports filter wheel 740 for rotation on a post 746 (FIG. 10). More particularly, wheel 740 is mounted on post 746 and may be freely rotated to put one of the filters, as described below, on wheel 740 over the output of focusing optics 738 and thus filter such output.

More particularly, light output from focusing optics 738 passes through a hole 748 (FIG. 9), through one of the filters 752-760 or hole 761, (in the illustrated case through selected filter 752), through hole 749, and then through hole 751 in front wall 750.

There is an alphanumeric designation 772 associated with each of the filters. Each alphanumeric designation 772, such as designation 772, designates the wavelength of its corresponding filter which is adjacent the location of the alphanumeric designation. For example, alphanumeric designation 772 is adjacent filter 752, whereas alphanumeric designation 774 is located adjacent to filter 754. Likewise, another alphanumeric designation 776 is located adjacent filter 758 and corresponds to the characteristics of filter 758. In similar fashion, alphanumeric designation 778 corresponds to the characteristics of filter 756. Other alphanumeric designations on the system are not described but are positioned in similar analogous fashion.

In accordance with the preferred embodiment, the system, or more particularly, filter wheels 740 has a hole, such as hole 761 in wheel 740 which does not include any filter and merely passes all light in order to output an uncolored or “white” light output. Hole 761 is a simple hole, in contrast with holes 780 which support the filters. Holes 780 have a suitable shoulder which supports the filter and are closed by a retainer spring ring 781 of conventional design, a plurality of which are employed in the system, each associated with one of the holes 780 in filter wheel 740, as illustrated in FIG. 10.

Filter wheel 740 may include a plurality of notches 786 along its periphery. Notches may be used in connection with a ball and spring follower which bears against the wheel and snaps into notches 786 to provide positive stops so that the filter wheel clicks into place in one of six specified positions. Filter wheel 740 may be rotated to any desired position through the use of knurled serrations 787 along its periphery to make rotation easier. In accordance with the preferred embodiment of the invention, the output of light source 726 is output at a fixed point on housing 712. When hole 761, which has no filter mounted in it, is lined up with the output point, then the unfiltered output spectrum of lamp 726 will be output by the system.

In accordance with the preferred embodiment of the invention, as discussed above, positive engagement of the wheel and maintenance of the position of the wheel at the desired preset points is achieved through the use of a spring follower mechanism which mates with detense or notches 786. The particular spring follower mechanism used in accordance with the present invention is a spring loaded ball bearing. More particularly, as the filter wheel is rotated, the ball 789 is forced into one of the detents or notches by spring 791 resulting in holding the filter in the desired position, as diagrammatically illustrated in FIG. 10.

In accordance with the present invention, ease of use and light weight may be optionally achieved by separating the light unit from the power supply, whether it be a battery pack or an electrical power supply operated by house current. However, in the embodiment illustrated in FIG. 9, a battery pack 798 incorporated within the unit 710 itself powers inventive system 710.

In accordance with an alternative embodiment of the invention, the inventive forensic light source 710 may be powered by house current. In this case, a conventional power supply is used and connected by a length of line cord to a house current source.

Light output through hole 751 in housing 712 is then coupled onto the input face 792 of mixing rod 794, which may be made of quartz, for example, and has a diameter of ten centimeters and a length of between 16 and 80 cm, although the diameter and length are a function of the diameter of the optical system, and the desired degree of mixing. Mixing route 794 also has rounded edges 795 at both it ends. Rounded edges 795 smooth out the transition from dark to light at the edges of the spot of light output by forensic light source 710. While such rounded edges are only necessary at the output end of mixing rod 794, they are included at both ends, so that the rod may be used with either orientation, thus simplifying assembly, use, and so forth. It is also noted that a relatively long mixing optic 794 can be tolerated in the system, and longer optics may thus be employed for better mixing.

The output of mixing optic 794 is, in turn, coupled to an output lens 796 which has a focal length of 90 mm. Lens 796 is mounted within turret 798, which in turn is held by annular support 800 on housing 712. Output lens 796 may be a 90 mm lens of the type typically used in a 35 mm camera, and may be used to focus the beam at various working distances ranging from, for example, 2 cm to 5 m. Moreover, by adjustment of lens 796, the size of the beam presented by the system over the area to be inspected for forensic evidence may be varied, as desired. As will be understood from the within description, light focused into a relatively small area will be relatively intense, while less intense illumination over a wider area may be employed.

Ideally, mixing optic 794 has no sharp edges and is chamfered or provided with a round radius at its outpost end 795. As noted above, the use of a rounded or chamfered edge at the output end gives the output spot of light a uniform smooth look.

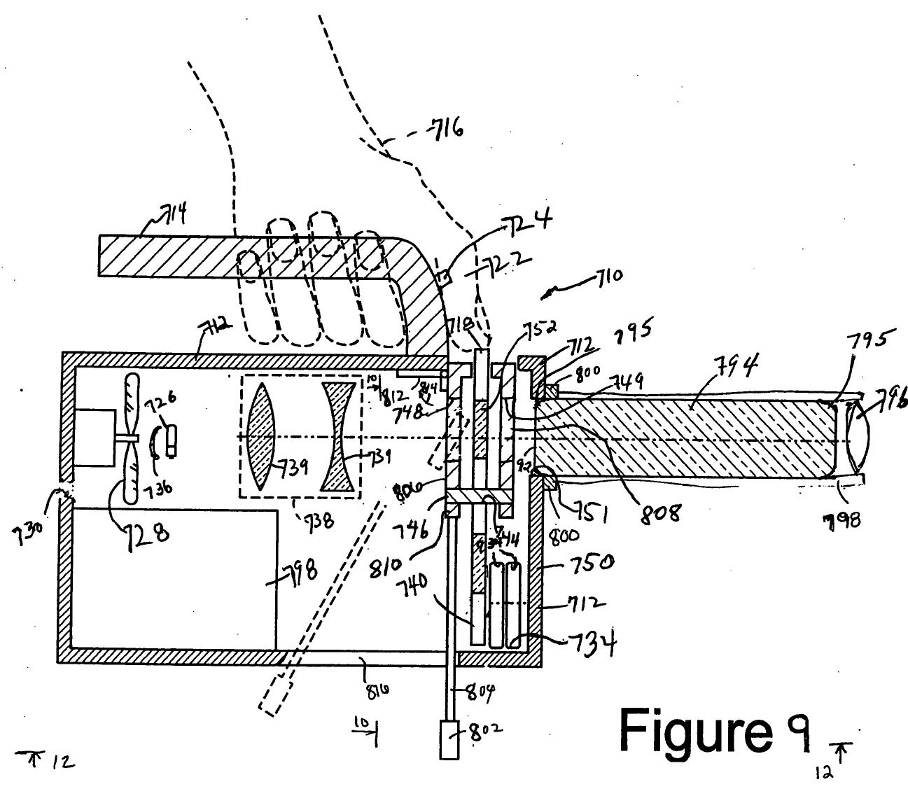

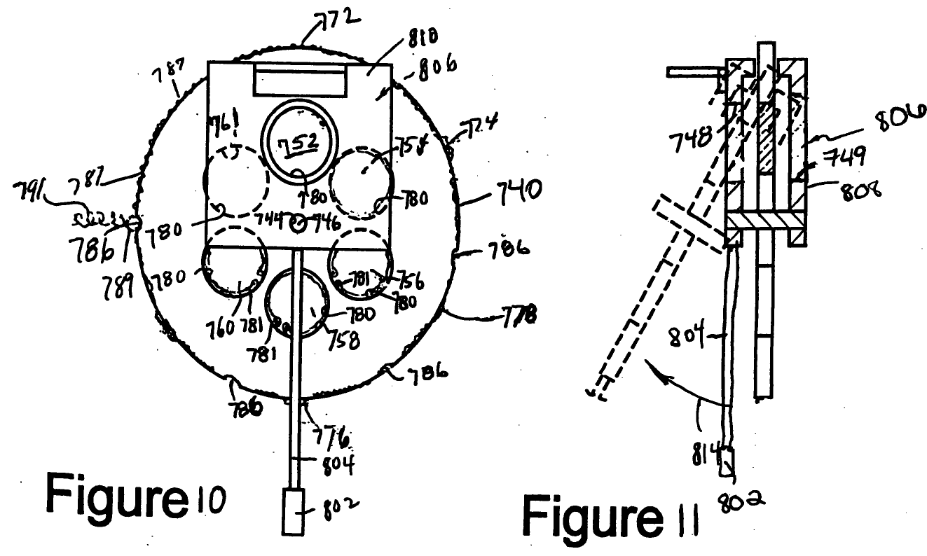

As will be understood with reference to FIG. 9, filter wheel 740 may be slanted as shown in phantom lines in FIG. 9 and FIG. 11. This may be done by grasping the knob 802 of lever 804 mounted on U-shaped support 806. Support 806 is generally U-shaped having an output face 808 and an input face 810. Hole 748 is defined in input face 810. Hole 749 is defined in output face 808. Support 806 is mounted for rotation on a hinge 812 which allows it to be moved in the direction of arrow 814 to the position illustrated in phantom lines in FIGS. 9 and 11 in chassis 714, with lever 802 riding in slot 816.

When it is desired to use the inventive system, switch 724 is actuated and fan 728 and lamp 726 are activated. Light produced by lamp 726 reflects off reflector 736 and is focused by lens 738, passing through filter 752, which has been rotated into position by rotation of wheel 740. Filter 752 is an interference filter, like the other filters in the system, and outputs colored light which passes through mixing rod 794 and is output in a focused form by lens 796. When it is desired to shift the wavelength of light filtered by filter 752, the user grasps knob 802 and moves it to the position shown in phantom lines in FIG. 12, from the position illustrated in FIG. 13.

Because filter 752 is tilted at an angle when it is placed in the position shown in phantom lines in FIG. 9, it presents a relatively longer path length between layers of the interference filter to light passing through the filter, resulting in the output of light of relatively long wavelength by the system into the input face 792 of mixing rod 794. Light traveling through mixing rod 794 is reflected, in turn, internally along many different paths. This results in mixing the light input at face 752. Thus, while there is a chromatic gradient across the face of mixing rod 794, the output of rod 794 is chromatically uniform.

In accordance with the invention, it is contemplated that mixing rod 794 is removably mounted on housing 712. Accordingly, it may be removed and replaced by a fiber-optic flexible light conducting members such as member 818, as illustrated in FIG. 14.

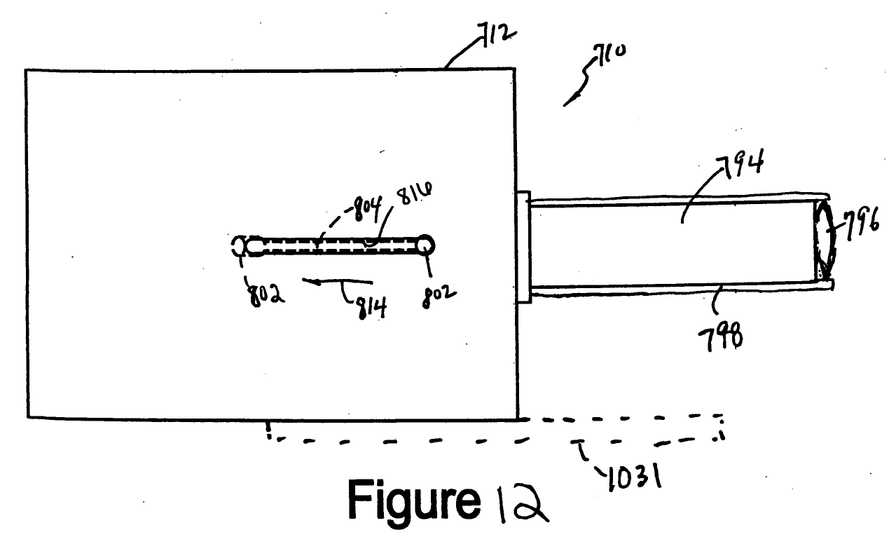

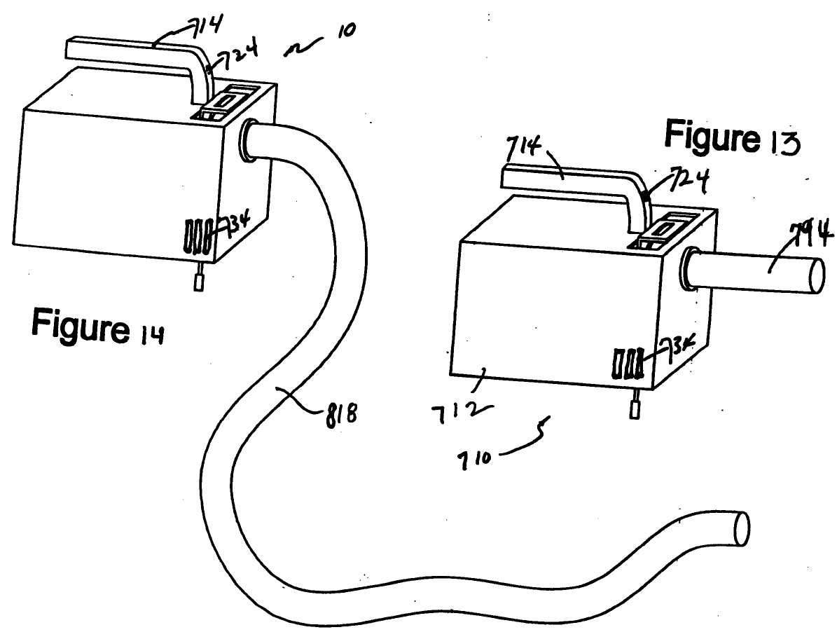

In accordance with an alternative embodiment of the invention, a forensic light source 910, illustrated in FIGS. 15-18, is constructed substantially the same as the embodiment illustrated in FIGS. 9-14, with the exception of the mounting mechanism. In accordance with this embodiment, support 1006 is mounted between a pair of yolks 1022. Yolks 1022 are mounted for rotation in chassis 914, as can be seen most clearly in FIG. 17. Because of the position of yolks 1022, tilting of filter 952, as illustrated in phantom lines in FIG. 15, is about an axis 1023 (FIG. 17) which intersects optical axis 1024 of the system, thus allowing the use of larger filters and a greater area of the filter.

Tilting of wheel 940 may be achieved through the use of handle 1002 by pulling handle 1002 toward the rear of the device, as illustrated in phantom lines in FIG. 15. Alternatively, the system may include, instead of handle 1002, a knob which is rotated, such as knob 1028 which is coupled to the shank 1029 of one of the yolks. Alternatively, the knob may be made much larger, as illustrated by knob 1031 in FIG. 12.

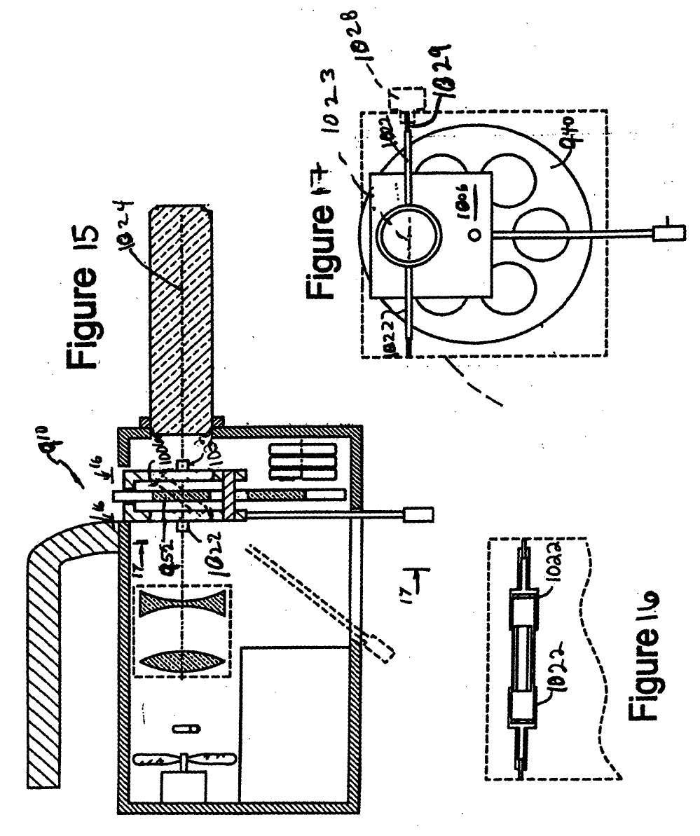

Referring to FIGS. 18 and 19, an alternative inventive forensic light source 1110 is illustrated. Forensic light source 1110 is substantially identical to the forensic light source illustrated in FIGS. 15-17 except that the system includes a pair of separately adjustable filter wheels 1140 and 1142. Wheels 1140 and 1142 are rotated separately by a pair of knobs 1228 and 1230. Thus, wheel 1142 may be rotated separately and wheel 1140 left in place, as illustrated in FIG. 19.

Because filters may be combined, bandpass and band reject and other characteristics may be superimposed on each other to get a variety of effects. Tilting of the filters, which is allowed by the system increases the range of these effects dramatically.

While a wide range of filters may be used, in accordance with the present invention, filter wheel 1140 has an open hole, which passes all light, and a plurality of filters. The filters in filter wheel 1140 have the following characteristics: a bandpass filter with a center wavelength of 440 nm with a relatively broad bandwidth in the range of 40 to 50 nm; a bandpass filter with a center wavelength of 490 nm with a relatively broad bandwidth in the range of 40 to 50 nm; a bandpass filter with a center wavelength of 540 nm with a relatively broad bandwidth in the range of 40 to 50 nm; a bandpass filter with a center wavelength of 590 nm with a relatively broad bandwidth in the range of 40 to 50 nm; and a short pass filter with a maximum pass wavelength of 540 nm (which functions as a crime scene scanning filter). The 540 nm filter is known as a crime scene scanning filter because it is most useful in searching over wide areas of a crime scene in order to identify areas for later closer inspection under light of various wavelengths.

In accordance with the present invention, it is also contemplated that a crime scene will be searched under white light and under light of various wavelengths, particularly in those areas of the crime scene likely to contain various types of evidence. In addition, to the extent that it is known that various specific types of evidence are most visible under the light of one wavelength or another, it is anticipated that in accordance with the invention that areas will be examined with light of the applicable wavelength or wavelengths.

The user uses light of different wavelengths to inspect the crime scene for materials which will only be revealed by light of a particular wavelength, or which will be revealed in a better and easier to identify fashion by light of a selected wavelength.

Filter wheel 1142 also has an open hole, which passes all light, and filters with the following characteristics: a bandpass filter with a center wavelength of 415 nm with a relatively broad bandwidth in the range of 40 to 50 nm; a bandpass filter with a center wavelength of 465 nm with a relatively broad bandwidth in the range of 40 to 50 nm; a bandpass filter with a center wavelength of 515 nm with a relatively broad bandwidth in the range of 40 to 50 nm; a bandpass filter with a center wavelength of 565 nm with a relatively broad bandwidth in the range of 40 to 50 nm; a bandpass filter with a center wavelength of 615 nm with a relatively broad bandwidth in the range of about 40 to 50 nm; and a bandpass filter with a center wavelength of 665 nm with a relatively broad bandwidth in the range of 40 to 50 nm.

In accordance with yet another embodiment of the invention, it is contemplated that the system may incorporate a third filter wheel which has a number of very narrow band reject filters. These may be selected to reject wavelengths which comprise certain commonly occurring excitation wavelengths which constitute noise and present the possibility of overpowering wavelengths which one wishes to detect or photograph.

While lamps of other power may be used, it is anticipated that the inventive system will be used with a 100 watt lamp.

Moreover, in accordance with the invention, it is contemplated that filters from both filter wheel 1140 and 1142 may be used simultaneously in order to have a more selective filtering of wavelengths of light output by lamp 1126. For example, if a filter having a center bandwidth of 415 nm is used simultaneously with the filter having a center bandwidth of 440 nm on the other filter wheel, the resultant filtering will have a center wavelength of approximately 427.5 nm and a bandpass characteristic whose largest wavelength is the longest wavelength passed by the 415 nm filter and a shortest wavelength which is the smallest wavelength passed by the 440 nm filter.

In this way, inventive system 1110, though it incorporates only a limited number of filters, can provide that number of wide bandwidth bandpass characteristics (using one of the filters in one of the filter wheels, with the other filter wheel set for an open hole which passes light all wavelengths) and eight narrow bandwidth bandpass characteristics (using combinations of relatively proximate wavelengths from each of the two filter wheels).

The above configuration allows for the individual use of nine broadband filters (for example, 415 nm, 440 nm, 465 nm, 490 nm, 515 nm, 540 nm, 565 nm, 590 nm, 615 nm), a short pass filter (crime scene scanning filter) and, for example, white light for searching the crime scene.

Additionally, with the configuration mentioned above, nine additional commercially useful wavelength filtering functions with relatively narrow bandwidth (20 to 25 nm) can be achieved. These narrow bandpass filtering capabilities at intermediate wavelengths are especially useful for photography at a crime scene and in many instances will provide improved contrast photographs.

For example, using the 415 nm filter of filter wheel 1140 and the 440 nm filter of filter wheel 1142, one obtains a resultant bandpass with a center wavelength of 427.5 nm; using the 440 nm filter of filter wheel 1142 and the 465 nm filter of filter wheel 1140, one obtains a resultant bandpass with a center wavelength of 452.5 nm; using the 465 nm filter of filter wheel 1140 and the 490 nm filter of filter wheel 1142, one obtains a resultant bandpass with a center wavelength of 477.5 nm; using the 490 nm filter of filter wheel 1142 and the 515 nm filter of filter wheel 1140, one obtains a resultant bandpass with a center wavelength of 502.5 nm; using the 515 nm filter of filter wheel 1140 and the 540 nm filter of filter wheel 1142, one obtains a resultant bandpass with a center wavelength of 527.5 nm; using the 540 nm filter of filter wheel 1142 and the 565 nm filter of filter wheel 1140, one obtains a resultant bandpass with a center wavelength of 552.5 nm; using the 565 nm filter of filter wheel 1140 and the 590 nm filter of filter wheel 1142, one obtains a resultant bandpass with a center wavelength of 577.5 nm; and using the 590 nm filter of filter wheel 1142 and the 615 nm filter of filter wheel 1140, one obtains a resultant bandpass with a center wavelength of 602.5 nm.

Further, using the 590 nm filter of filter wheel 1140 and the crime scene scanning filter of filter wheel 1142, one obtains an asymmetrical filtering characteristic that represents the juxtaposition of the two characteristics of the two filters. There is a sharp decline in fluorescence transmission at the high-end while excitation reflection is blocked. This is useful for highly reflective surfaces, such as aluminum.

Still further variation may be achieved by tilting one or both of the filter wheels. For example, if a 415 nm filter is superimposed with a 450 nm filter, the result will be a peak wavelength output at 432.5 nm, if the 450 nm filter is not tilted. If, however, the 450 nm filter is tuned by being tilted, the peak wavelength passed will become longer, with the increase in wavelength proportional to the angle of tilt. This allows one to bring the output wavelength to a point where it matches exactly the blocking range of a camera long pass or bandpass filter and has substantially zero transmission in the camera filter range. The result is to only allow fluorescent light to pass. There is also the potential to combine typical blocking factors ranging between 10-3 to 10-5, resulting in blocking factors reaching purity levels ranging between 10-6 to 10-10.

If two bandpass filters are tilted, the result will be an average bandpass which is the average of the effective tilted bandpass wavelengths of both of the filters.

Thus, the potential is to adjust the bandwidth while the peak wavelength is shifting, further enhancing contrast in, for example, evidence photography. This may be done by tuning down the 450 nm wavelength, shifting the peak down (assuming the combination of a 450 nm filter and a 415 nm filter) and increasing bandwidth allowing more intensity to illuminate the evidence.

It is further contemplated that three or more filter wheels may be used in accordance with the present invention. The same may be used to provide an increased number of broad band filters. The use of three or more filter wheels will also provide greater flexibility in making combinations of different filters. These filters may also be used together to achieve increasingly narrow bandpass filtering. In addition, the use of three or more filter wheels will allow selection of bandpass widths. For example, it may be desired in some cases to combine a 590 nm filter with a 565 nm filter having a first bandwidth while at other times to combine the same 590 nm filter with a 565 nm filter having a second bandwidth, in order to vary the resultant bandwidth. This can be accommodated through the use of additional filter wheels, or filter wheels with greater numbers of filters on them.

Still yet another possibility in accordance with the present invention is the employment of a mixing member having a rectangular cross-section. The use of a transparent rectangular cross-section rod to mix wavelengths has the advantage of presenting the possibility of matching the shape of the projected light source on a workpiece to the shape of a utilization device, such as a CCD array, photographic film frame, etc.

In accordance with the invention, as illustrated in FIG. 20, a square mixing rod 1294 made of optically transparent material having a diameter of, for example, 12 mm and a length of 60 mm to 80 mm may be employed, for example, in the embodiment of FIG. 1. However, it is noted that in the case of a rectangular mixing member, a lens 1296, in addition to performing a focusing function is also useful in maintaining the square shape (or rectangular shape) of the image projected by the mixing member.

In accordance with the invention, it is contemplated that the inventive forensic illumination device may include a number of optional features. For example, the system may include an iris in order to serve to spotlight a relatively small area, or to vary the intensity of light falling on an object, for example, for security purposes, to accommodate photography or to prevent deterioration of a sample. If desired, the light source may be provided with an elliptical reflector with the light source, whether it be a filament, arc gap or the like, with the light source placed at one of the foci of the elliptical reflector. In addition, it is contemplated that the reflector may be provided with an ultraviolet reflective coating to enhance the output of the light source in the ultraviolet portion of the spectrum. Similarly, lenses in the system may be accommodated to transmit a maximum of ultraviolet light being made of appropriate materials and provided with appropriate coatings.

Likewise, it is contemplated that in addition to using one or more filter wheels, some of the wheels may be made tilting or all of the wheels may be made tilting.

Likewise, the filters may include only a few filters, for example four or a greater number of filters, for example twelve. Likewise, filter wheels tilting may be limited to, for example, a relatively as small amount of tilting such as ten or twenty degrees, or a range to greater degrees of tilting such as forty degrees.

Light guides may be liquid light guides or fiber-optic bundles. The system may also include a motorized shutter, or a fish tail may be employed. The power supply may be a plug-in household current power supply, a rechargeable battery, or a non rechargeable battery.

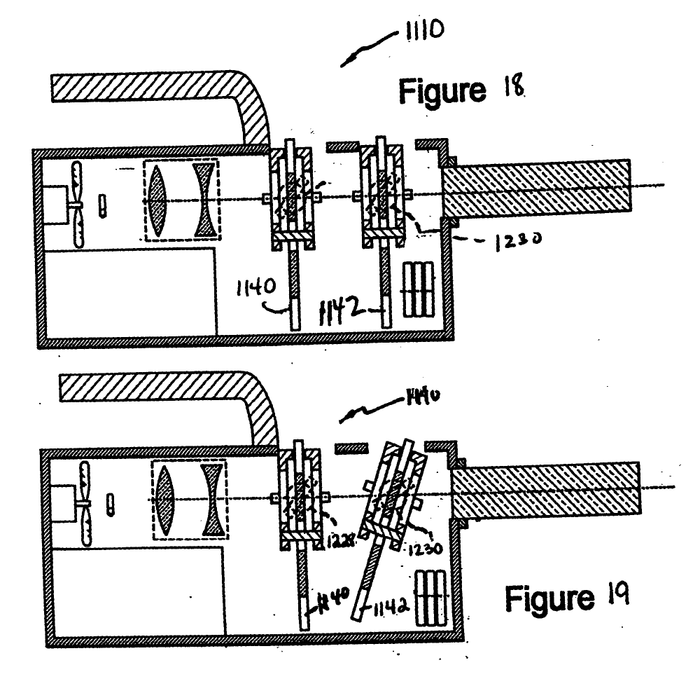

Referring to FIG. 21, yet another possibility for an optical mixing member, such as rod 58, is a hollow mixing sphere 1358 having an input hole 1392 and an output hole 1393. The inside 1359 of sphere 1358 is reflective. The inside of sphere 1358 also surrounds a baffle 1361, which may be reflective, but which will block direct transmission of light from input hole 1392 to output hole 1393. Multiple reflections within mixing member 1358 result in uniform light output from hole 1393.

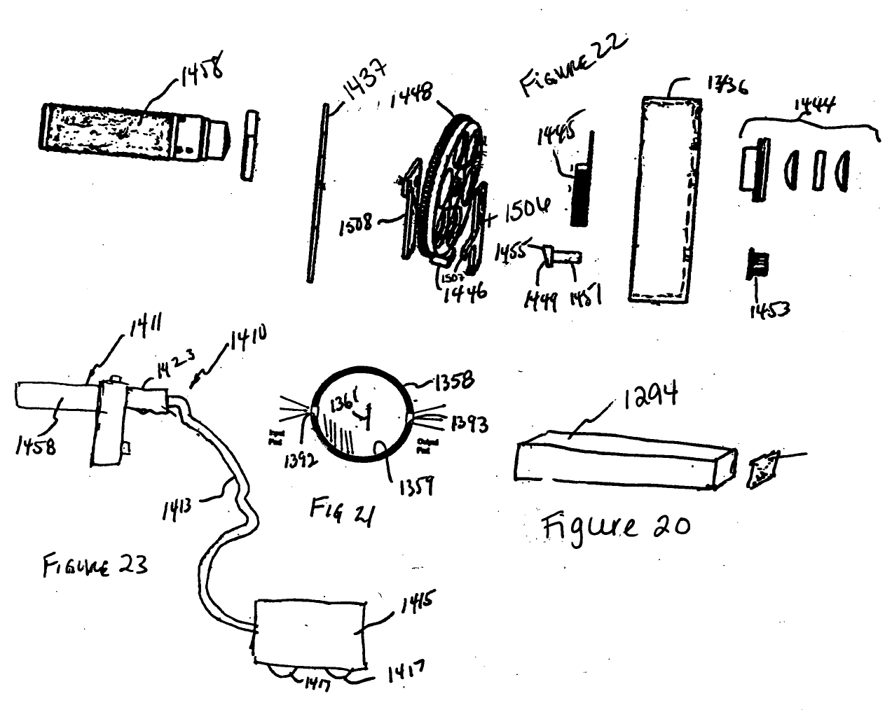

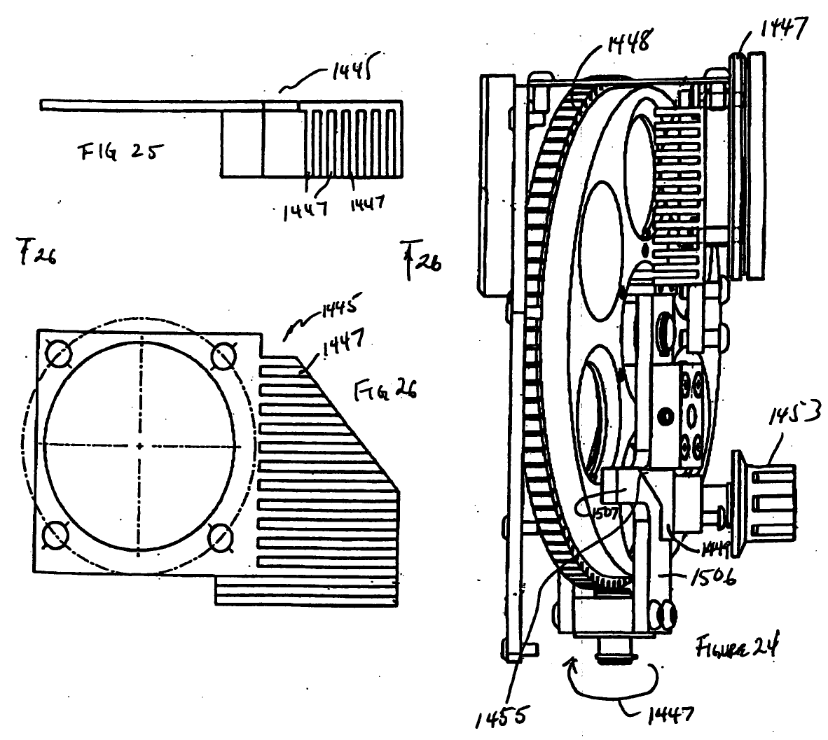

Another embodiment of the invention is illustrated in FIGS. 22-26. In accordance with this embodiment of the invention, as illustrated by the exploded perspective of FIG. 22, a forensic light source 1410 comprises a handheld light gun 1411 coupled by a flexible fiber optic light guide or liquid light guide 1413 to a power supply and light source 1415. Light source 1415 is on wheels 1417 which allow it to be wheeled conveniently around a site while still providing a very light handheld light gun portion 1411. In particular, a user may use source 1410 by grasping handle 1423 and aiming mixing member 1458 in a desired direction.

In accordance with this embodiment of the invention, a filter wheel 1448 is mounted on a U-shaped support comprising a forward arm 1508 and a rearward arm 1506, coupled together by a base 1446. Arm 1506 includes a tine 1507. The U-shaped support, comprising a forward arm 1508 and a rearward arm 1506, coupled together by a base 1446, is rotated in the direction of arrow 1447 in FIG. 24. Rotation is achieved by rotation of cam 1449 which is mounted on support rod 1451 and coupled to knob 1453. Support rod 1451 is mounted on housing 1436 which is, in turn, closed by housing cover 1437. As cam 1449 is rotated, its forward surface 1455 bears against tine 1507, causing rotation in the direction of arrow 1447. This may be most easily understood from FIG. 24 which shows the filter rotating mechanism in assembled format

It is noted that substantial radiant energy, during operation of the system, is input through lens assembly 1444. Accordingly, a heatsink 1445 including a plurality of heat dissipating wings 1447, in order to prevent overheating. Heatsink 1445 may be secured to the flange 1447 of lens assembly 1444.

While an illustrative embodiment of the invention has been described, it is, of course, understood that various modifications of the invention will be obvious to those of ordinary skill in the art. Such modifications are within the spirit and scope of the invention which is limited and defined only by the appended claims.

1. A forensic light source, comprising:
(a) a source of light outputting light having a plurality of wavelengths;
(b) a flexible light guide, having an input end and an output end, said flexible light guide receiving light from said source at said input end of said flexible light guide and transmitting said light to said output end;
(c) a filter for receiving light output by said output end of said flexible light guide and providing a filtered light output, said filtered light output having a wavelength characteristic different from the wavelength characteristic of light received by said filter;
(d) a mounting for supporting said filter at selectable angular position of said filter relative to said output end of said light guide to receive light from said output end of said light guide and to vary, in response to said relative angular position, the wavelength of light output by said filter;
(e) a mixing member having a mixing member input face with a plurality of mixing member input face regions and a mixing member output face with a plurality of mixing member output face regions, said mixing member positioned to receive the output of said filter, and said mixing member defining multiple paths for light between the mixing member input face and a mixing member output face which are configured to disperse light from one mixing member input face region to a plurality of mixing member output face regions.

2. A forensic light source as in claim 1, wherein said flexible light guide is a liquid light guide-liquid.

3. A forensic light source as in claim 2, wherein said liquid light guide is less than one meter in length.

4. A forensic light source as in claim 1, wherein said filter for receiving light output by said output end of said flexible light guide is an interference filter.

5. A forensic light source as in claim 1, wherein said filter for receiving light output by said output end of said flexible light guide is a selected one of a plurality of filters carried on a rotatable filter-supporting wheel.

6. A forensic light source as in claim 5, wherein said filter wheel is contained within a support chassis, and said filter wheel tilts within said support chassis.

7. A forensic light source as in claim 5, wherein said output end of said flexible light guide tilts with respect to said filter wheel.

8. A forensic light source as in claim 1, wherein said mixing member is removable.

9. A forensic light source as in claim 1, wherein said mixing member is a solid transparent member.

10. A forensic light source as in claim 1, wherein said mixing member generally rectangular in cross-section.

11. A forensic light source as in claim 1, wherein said mixing member has a length to width ratio between 5 to 1 and 10 to 1.

12. A forensic light source as in claim 1, wherein said mixing member comprises a randomized fiber-optic bundle.

13. A forensic light source as in claim 1, wherein said mixing member comprises a compartment filled with a large number of light transparent members.

14. A forensic light source as in claim 1, wherein said filter for receiving light output by said output end of said flexible light guide is a selected one of a plurality of filters carried on a rotatable filter-supporting wheel, said filter supporting wheel being mounted on a post, said post being supported for tilting on a tilting support.

15. A forensic light source, comprising:
(a) a source of light having a plurality of wavelengths;
(b) a flexible light guide, having an input end and an output end, said flexible light guide receiving light from the source at said input end and transmitting said light to said output end;
(c) a filter for receiving light output by said output end of said flexible light guide;
(d) a mounting for supporting said filter and said output end of said flexible light guide with a desired adjustable angular orientation with respect to each other at a position where said filter receives light from said output end of said light guide and allows a user to tilt the position of said filter relative to said output end of said light guide to vary the wavelength of light output by said filter, said filter producing a plurality of wavelengths at its output face when it is tilted at certain angles;
(e) an equalizing member having an optical characteristic equalizing the wavelength output of said filter across the face of said filter.

16. A forensic light source as in claim 15, wherein said equalizing member comprises a second filter.

17. A forensic light source, comprising:
(a) a housing;
(b) a source of light outputting light at a plurality of wavelengths;
(c) a first filter, contained within said housing and receiving light output by said source of light along a path of propagation extending through said filter and providing a filtered light output, said filtered light output having an output wavelength characteristic different from the wavelength characteristic of light received by said filter, said output wavelength characteristic varying in response to the angular orientation of said filter relative to said path of propagation;
(d) a first mounting for supporting said filter at a selectable angular orientation of said filter relative to the path of propagation to vary said output wavelength characteristic, in response to said selectable angular orientation;
(e) a mixing member having a mixing member input face, said mixing member input face having a plurality of mixing member input face regions, and a mixing member output face, said mixing member output face having a plurality of mixing member output face regions, said mixing member positioned to receive the output of said filter, and said mixing member defining multiple paths for light between the mixing member input face regions and the mixing member output face regions, said paths being configured to disperse light from one mixing member input face region to a plurality of mixing member output face regions.

18. A forensic light source as in claim 17, further comprising a flexible light guide wherein said mixing member is removably mounted relative to said housing and may be removed to receive said flexible light guide.

19. A forensic light source as in claim 18, wherein said mixing member is less than forty centimeters in length.

20. A forensic light source as in claim 17, wherein said filter for receiving light output by said output end of said flexible light guide is an interference filter.

21. A forensic light source as in claim 17, wherein said mounting for supporting said filter comprises a filter-supporting wheel, and further comprising a plurality of additional filters mounted on said filter-supporting wheel, said filter-supporting wheel being rotatably mounted on said housing.

22. A forensic light source as in claim 21, wherein said filter wheel is contained within said housing and said filter wheel is mounted for rotation on a bracket, and said bracket tilts within said housing.

23. A forensic light source as in claim 21, wherein said output end of said flexible light guide tilts with respect to said filter wheel.

24. A forensic light source as in claim 17, wherein said a first mounting for supporting said filter at a selectable angular orientation of said filter relative to the path of propagation to vary said output wavelength characteristic, in response to said selectable angular orientation comprises a cam and cam follower, said cam follower being secured to said first mounting and said cam being secured to a cam support member mounted on said housing.

25. A forensic light source as in claim 17, wherein said light source is in a separate housing, said the separate housing being mounted on wheels and coupled to said filter by a flexible optical guide.

26. A forensic light source as in claim 17, wherein said mixing member generally rectangular in cross-section.

27. A forensic light source as in claim 17, wherein said mixing member has a length to width ratio between 5 to 1 and 10 to 1.

28. A forensic light source as in claim 17, wherein said mixing member comprises a randomized fiber-optic bundle.

29. A forensic light source as in claim 17, wherein said mixing member comprises a compartment filled with a large number of light transparent members.

30. A forensic light source as in claim 17, wherein said filter for receiving light output by said output end of said flexible light guide is a selected one of a plurality of filters carried on a rotatable filter-supporting wheel, said filter supporting wheel being mounted on a post, said post being supported for tilting on a tilting support.

31. A forensic light source as in claim 17, further comprising:
(f) a second filter for receiving light output by said output end of said flexible light guide along a path of propagation extending through said first filter and providing a twice-filtered light output, said twice-filtered light output having a twice-filtered output wavelength characteristic different from the wavelength characteristic of light output by said first filter, said twice-filtered output wavelength characteristic varying in response to the angular orientation of said second filter relative to said path of propagation; and
(g) a second mounting for supporting said second filter at a selectable angular orientation of said second filter relative to said path of propagation to vary said twice-filtered output wavelength characteristic and pass said twice-filtered light output to said mixing member input face.

32. A forensic light source as in claim 31, wherein said first and second mountings for supporting said first and second filters comprise first and second filter-supporting wheels, and further comprising a plurality of additional filters mounted on each of said filter-supporting wheels, said filter-supporting wheels being rotatably mounted on said housing.

33. A forensic light source, as in claim 17, wherein said mixing member is rigid.

34. A forensic light source as in claim 19, further comprising:
(f) a battery contained within said housing.

35. A forensic light source as in claim 33, further comprising:
(f) a battery pack contained located external to said housing; and
(g) a belt or strap secured to and supporting said battery pack.

36. A forensic light source, comprising:
(a) a housing;
(b) a source of light, contained within said housing and outputting light at a plurality of wavelengths;
(c) a first filter for receiving light output by said output end of said flexible light guide along a path of propagation extending through said filter and providing a filtered light output, said filtered light output having an output wavelength characteristic different from the wavelength characteristic of light received by said filter;
(d) a first mounting for supporting said filter at a desired position on the path of propagation; and
(e) a rigid transparent member secured to said housing and positioned to receive the output of said filter, and said rigid transparent member defining multiple paths for light between a rigid transparent member input face and a rigid transparent member output face.

37. A forensic light source, comprising:
(a) a housing;
(b) a source of light, contained within said housing and outputting light at a plurality of wavelengths;
(c) a first filter for receiving light output by said output end of said flexible light guide along a path of propagation extending through said filter and providing a filtered light output, said filtered light output having an output wavelength characteristic different from the wavelength characteristic of light received by said filter, said output wavelength characteristic varying in response to the angular orientation of said filter relative to said path of propagation;
(d) a first mounting for supporting said filter at a selectable angular orientation of said filter relative to the path of propagation to vary said output wavelength characteristic, in response to said selectable angular orientation;
(e) a second filter for receiving light output by said output end of said flexible light guide along a path of propagation extending through said first filter and providing a twice-filtered light output, said twice-filtered light output having a twice-filtered output wavelength characteristic different from the wavelength characteristic of light output by said first filter, said twice-filtered output wavelength characteristic varying in response to the angular orientation of said second filter relative to said path of propagation; and
(f) a second mounting for supporting said second filter at a selectable angular orientation of said second filter relative to said path of propagation to vary said twice-filtered output wavelength characteristic and pass said twice-filtered light output to said mixing member input face.

38. A forensic light source as in claim 37, wherein said first and second mountings for supporting said first and second filters comprise first and second filter-supporting wheels, and further comprising a plurality of additional filters mounted on each of said filter-supporting wheels, said filter-supporting wheels being rotatably mounted on said housing.

39. A forensic light source comprising:
(a) a housing;
(b) a light source contained within said housing, said light source having a light output;
(c) a power supply coupled to said light source;
(d) a first tiltably mounted filter support member adjustably and movably mounted on said housing, said first filter support member comprising (i) a plurality of first filter receiving supports, and (ii) a plurality of first light filters each positioned in one of said first filter receiving supports, said first filter support member being adjustable to position any one of said first light filters to receive said light output and to filter said light output to produce a filtered light output and transmit said filtered light output; and
(e) a second tiltably mounted filter support member adjustably and movably mounted on said housing, said second filter support member comprising (i) a plurality of second filter receiving supports, and (ii) a plurality of second light filters each positioned in one of said second filter receiving supports, said second filter support member being adjustable to position any one of said second light filters to receive said filtered light output and to filter said filtered light output to produce a twice filtered light output and transmit said twice filtered light output.

40. A light source as in claim 39 wherein said light source further comprises a handle secured to said housing, said handle being positioned and configured to be held by one hand and said the first and second filter support members being positioned to be adjusted by the thumb of said one hand.

41. A light source as in claim 39 further comprising a fan, and wherein said housing has at least one opening for air intake by said fan, and at least one opening for air exhaust by said fan.

42. A light source as in claim 39, further comprising focusing optics, said focusing optics dimensioned and configured to allow the user to focus light from said light source.

43. A light source as in claim 39, further comprising a reflective member, positioned to reflect light from said light source toward said focusing optics.

44. A light source as in claim 42, wherein said power supply is an external battery pack.

45. A light source as in claim 39, wherein said power supply is an external transformer and connection to a standard household power supply.

46. A light source as in claim 39, wherein at least one of said filter support members comprises a rotatably mounted light filtering wheel which defines a hole which does not contain a filter to allow light to be passed through said hole without being filtered.

47. A light source as in claim 39, further comprising a power control switch, said power control switch having settings which turn the light and fan on simultaneously, turn the fan while keeping the light off, and keep the light and fan off.

48. A light source as in claim 39 wherein said first and second filter support members are light wheels and said filters are bandpass filters, said filters being arranged such that their wavelengths, when arranged in a sequential order, are alternately placed on said first wheel and then said second wheel.

49. A light source as in claim 48, wherein the selection of one filter on said first wheel and the selection of a second filter on said second wheel results in a bandpass narrower than the bandpass of said one filter or said second filter, the combined characteristic of said one filter and said second filter being formed by the juxtaposition of the characteristics of said one filter and said second filter and a bandpass wavelength range between said one and said second filters, and a narrower bandwidth than either said one or said second filters.

50. A light source as in claim 49, further comprising a third filter wheel holding a plurality of additional filters.

51. A light source as in claim 49, wherein in said third filter wheel mounts a plurality of band reject filters, said band reject filters selected to reject wavelengths which comprise certain commonly occurring exultation wavelengths which constitute noise and present the possibility of overpowering wavelengths which one wishes to detect or photograph.

52. A forensic light source comprising:
(a) a first housing;
(b) a second housing;
(c) a light source contained within said first housing, said light source having a light output;
(d) a first tiltably mounted filter support member adjustably and movably mounted on said second housing, said first filter support member comprising
(i) a plurality of first filter receiving supports, and (ii) a plurality of first light filters each positioned in one of said first filter receiving supports, said first filter support member being adjustable to position any one of said first light filters to receive said light output and to filter said light output to produce a filtered light output and transmit said filtered light output; and
(e) a second tiltably mounted filter support member adjustably and movably mounted on said housing, said second filter support member comprising (i) a plurality of second filter receiving supports, and (ii) a plurality of second light filters each positioned in one of said second filter receiving supports, said second filter support member being adjustable to position any one of said second light filters to receive said filtered light output and to filter said filtered light output to produce a twice filtered light output and transmit said twice filtered light output.
